(19) United States
(12) Patent Application Publication
(10) Pub. No.: US 2026/0365566 A1
(43) Pub. Date: Nov. 19, 2026

(54) METHOD FOR HYDROPHOBICIZING AN AEROSPACE GLAZING

(71) Applicant: SAINT-GOBAIN SULLY, SULLY-SUR-LOIRE (FR)

(72) Inventors: Thomas TONDU, CAVAILLON (FR); Catherine DESCUSSE, SULLY-SUR-LOIRE (FR)

(21) Appl. No.: 19/132,201

(22) PCT Filed: Nov. 22, 2023
(86) PCT No.: PCT/EP2023/082752

§ 371 Date: May 22, 2025

(30) Foreign Application Priority Data
Nov. 25, 2022 (FR) FR2212362

(51) Int. Cl. C03C 17/30; B64C 1/14

(52) U.S. Cl. CPC C03C 17/30; B64C 1/1484; C03C 2217/76

(57) ABSTRACT

A method for hydrophobicizing a glass substrate includes successively forming a primer layer on one of the main surfaces of the glass substrate, grafting a layer of C₃-C₈ alkyltrialkoxysilane and/or C₃-C₈ alkyltrichlorosilane onto the primer layer, and optionally performing a glossing procedure using a water/alcohol mixture.

The present invention relates to a glass substrate, in particular an aircraft cockpit glazing, the surface of which has been rendered hydrophobic by grafting non-fluorinated alkylsilanes, and to a method for manufacturing such a substrate.

Hydrophobic properties are sought for windscreens in the transport sector, in particular for aircraft such as airplanes and helicopters, for which certification authorities (aeronautical regulations CS25 and FAR25) require sufficiently large and transparent glazing zones to ensure adequate vision in the event of rain, without pilot intervention. These transparent vision zones can be created by wiping away rain using windscreen wipers. The flow of raindrops is promoted by the hydrophobic properties of the glazing surface.

Several types of aeronautical glazing are used, but they generally consist of a laminated assembly consisting of several sheets of structural materials bonded together using adhesives or what are referred to as “interlayers”. The outermost sheet of structural material in the glazings is generally made of glass, a material which has intrinsic hydrophilic properties. In order to limit visual disturbances caused by rain, it is therefore necessary to carry out a method for hydrophobicizing the outer face of this glass sheet.

The hydrophobicization method must both allow rainwater to drain off efficiently and preserve the optical quality of the glazing. High contact angles (0) for a water droplet are sought which, on the one hand, reduce the wetted surface area of the glazing and, on the other, increase the aerodynamic forces exerted on the droplets, enabling them to flow during flight. In addition, hydrophobic treatments reduce the adhesion forces of droplets, thereby encouraging them to flow either under the effect of gravity or under the effect of aerodynamic forces. Hydrophobic coatings thus prevent the formation of continuous films of water which are the worst optical deterioration.

Two parameters can be used to characterize the hydrophobic nature of the surface of a glazing:
the contact angle (θ) of a water droplet deposited on a horizontal substrate, and
the roll-off volume of a water droplet deposited on an inclined surface.

The hydrophobicity of windows must, of course, withstand abrasion for as long as possible, in particular abrasion by dust present in the atmosphere, and also withstand the effects of the natural environment (water, leading to hydrolysis of the deposits, and UV radiation) and of the industrial environment (cleaning products). However, known hydrophobic treatments do not guarantee sufficient hydrophobicity throughout the life of the glazings.

As a result, visibility in the event of rain generally becomes inadequate when droplet contact angles are less than 50°.

Methods for hydrophobicizing glazing must be able to be implemented in situ, that is on glazing mounted on the aircraft, in order to enable quick and easy maintenance. This is referred to as regeneration of the hydrophobic function. Thus, a good hydrophobic treatment, in addition to being durable, must require a limited amount of equipment (including safety equipment), a limited number of steps and a short implementation time.

It is known to increase the hydrophobicity of vehicle glazings by grafting perfluorinated alkylsilanes onto the outer surface of the glass sheet, generally after prior creation of a silica primer layer by a sol-gel process, magnetron sputtering or chemical vapor deposition (CVD).

However, perfluorinated compounds are considered to be harmful to the environment and human health. The persistent nature of these compounds in the environment and in the human body, combined with their adverse effects on health, has recently increased regulatory pressure regarding their use, notably via the European REACH and POP regulations. This could lead to an extensive ban on these compounds by 2025, or 2030 at the latest.

The aim of the present invention is to propose a method for hydrophobicizing glass substrates intended for the aeronautical industry, which method makes it possible to obtain glazings having a satisfactory and persistent hydrophobic nature which can be regenerated on the aircraft without the use of perfluorinated compounds.

As part of its research with the aim of finding non-toxic molecules that could replace the perfluorinated alkylsilanes that have been used to date for hydrophobicizing glass substrates, the Applicant has tested a large number of hydrophobic functional silanes having non-hydrolyzable hydrocarbon chains that are short, that is that comprise from 1 to 8 carbon atoms (C₁ to C₈).

All the alkylsilanes tested made it possible, after deposition, to achieve satisfactory water droplet contact angles (θ), that is of greater than 50°, or even greater than 95°, and for some even greater than 100°, as well as roll-off volumes that differ very little from those obtained after grafting 1H,1H,2H,2H-perfluoroalkyltriethoxysilane (SiF5E). However, a deterioration in hydrophobic performance was observed following exposure to water and UV.

The present invention is based on the discovery that fatty-chain C₃ to C₈ alkylsilanes provide satisfactory durability with respect to both hydrolysis and UV. Alkyl chains shorter than C₃ provided insufficient resistance to hydrolysis, and longer alkyl chains (>C₈) gave rise to deposits which were too sensitive to UV.

The present application thus relates to a method for hydrophobicizing a glass substrate, the method comprising the following successive steps:
forming a primer layer, preferably of silica, on one of the main surfaces of the glass substrate,
grafting of a layer of C₃-C₈ alkyltrialkoxysilanes and/or C₃-C₈ alkyltrichlorosilanes onto the primer layer.

Another technical problem encountered during the tests was the milky appearance of the alkylsilane deposits obtained, particularly in the case of application by wiping. The treated surface of the glazings was slightly scattering, thereby unacceptably reducing the transparency and shine of the glazing. It was possible to overcome this problem by virtue of a glossing step, carried out after the step of grafting the C₃-C₈)alkyltrialkoxysilane and/or C₃-C₈)alkyltrichlorosilane layer. This glossing step is advantageously carried out by rubbing the surface using a cloth soaked in a solvent, advantageously a mixture of water and alcohol, until specular light reflection is re-established across the entire treated surface. The water/alcohol mixture is preferably a water/isopropanol mixture and contains from 30 to 90% by weight of water, preferably from 50 to 80% by weight of water.

The method for hydrophobicizing a glass substrate of the present invention therefore further comprises, after the grafting step, an additional glossing step.

The present application also relates to a glass substrate obtained by the above method. This hydrophobic glass substrate comprises a transparent glass substrate which is covered, on one of its main faces, with a primer layer, preferably of silica, said primer layer being grafted with C₃-C₈ alkylsilyl groups.

The glass substrate obtained by the method of the invention is preferably an aircraft cockpit window, in particular an airplane windscreen.

According to a first embodiment, the C₃-C₈ alkyltrialkoxysilane is an alkyltrialkoxysilane of formula CₙH₂ₙ₊₁SiR₃, where n=3-8, preferably n=5-8, and each R represents a C₁₋₃ alkoxy group, preferably a methoxy or ethoxy group.

According to one embodiment, the C₃-C₈ alkyltrichlorosilanes are preferably alkyltrichlorosilanes of formula CₙH₂ₙ₊₁SiR₃, where n=3-8, preferably n=5-8, and each R represents a chlorine atom.

The best performance is obtained with a trialkoxysilane or trichlorosilane of formula CₙH₂ₙ₊₁SiR₃, where n=8.

n=5-8 means that n can assume any integer value between 5 and 8, limit values included.

In order to obtain good durability of the hydrophobic coating on the glass substrate, it is essential to form a primer layer beforehand on the surface to be treated, preferably a silica primer layer.

In order for this primer layer to be effective in anchoring the hydrophobic coating of alkyltrialkoxysilane and/or alkyltrichlorosilane on the substrate, it is important for it to comprise as many active silanol groups (Si—OH) as possible, that is groups which are capable of reacting with the silanol groups released by the hydrolysis of the alkoxy groups or of the chlorine atoms.

Furthermore, it is advisable to precede the step of forming the primer layer with a step of polishing the substrate, for example by means of a felt impregnated with an aqueous solution of fine abrasive particles, following by rinsing with water and drying. In the case of regeneration of the hydrophobic function, this step is even essential in order to completely eliminate the pre-existing degraded layer.

The silica primer layer is formed in a sol-gel step wherein a tetrachlorosilane and/or tetraalkoxysilane, preferably tetraethoxysilane, is hydrolyzed in an acidic aqueous-alcoholic medium.

To implement this step, a suitable quantity of tetrachlorosilane and/or tetraalkoxysilane is dissolved in a water/alcohol mixture, typically an acidic water/isopropanol mixture, containing 3 to 50% by weight, preferably 5 to 15% by weight, of water, the pH of which has previously been adjusted to a value between 0 and 3. The tetrachlorosilane and/or tetraalkoxysilane content of this aqueous-alcoholic solution is advantageously between 0.1 and 1% by weight, preferably between 0.15 and 0.8% by weight.

It is preferable not to apply the aqueous-alcoholic solution immediately after dissolving the tetrachlorosilane/tetraalkoxysilane, but to allow hydrolysis to take place at room temperature (20-25 °C) for a period of between 2 minutes and 2 hours, preferably between 3 minutes and 1 hour, in particular between 5 minutes and 30 minutes.

In principle, the acidic aqueous-alcoholic solution of the tetrachlorosilane/tetraalkoxysilane can be applied by any technique enabling the formation of a thin liquid film on the surface of the substrate. Mention may be made, by way of example, of application by immersion, curtain coating, spraying or wiping. Wiping is best-suited to regeneration operations on aircraft. Use will preferably be made of spraying or nebulizing, and application by means of a cloth soaked in the aqueous-alcoholic solution of tetrachlorosilane/tetraalkoxysilane.

After application to the surface of the glass substrate, the liquid film formed is left to dry for a period of at least 2 minutes, preferably at least 15 minutes.

After the first deposit has dried, it is possible to reapply the aqueous-alcoholic solution of tetrachlorosilane/tetraalkoxysilane until the desired silica primer layer thickness is achieved.

The silica primer layer advantageously has a thickness of between 5 nm and 250 nm, preferably between 10 nm and 100 nm, in particular between 15 nm and 75 nm.

The grafting of C₃-C₈ alkyltrialkoxysilane and/or C₃-C₈ alkyltrichlorosilane is carried out after at least 2 minutes of drying of the silica primer layer at room temperature.

Like the formation of the silica primer layer, the step of grafting the alkyltrialkoxysilane or alkyltrichlorosilane is carried out by a sol-gel step wherein the alkyltrialkoxysilane and/or alkyltrichlorosilane is hydrolyzed in an acidic aqueous-alcoholic medium. It can be implemented in a similar way to that used for the formation of the primer layer.

The grafting composition is an acidic aqueous-alcoholic (water/isopropanol) solution of the C₃-C₈ alkyltrialkoxysilane and/or of the C₃-C₈ alkyltrichlorosilane. The content of C₃-C₈ alkyltrialkoxysilane and/or of C₃-C₈ alkyltrichlorosilane in the acidic aqueous-alcoholic solution is preferably between 0.1% and 4% by weight, and in particular between 1 and 3.5% by weight.

The water/alcohol mixture wherein the alkyltrialkoxysilane and/or alkyltrichlorosilane is dissolved contains 5 to 70% by weight, preferentially between 10 and 50% by weight, of water.

The aqueous-alcoholic solution of C₃-C₈ alkyltrialkoxysilane and/or of C₃-C₈ alkyltrichlorosilane is advantageously left at room temperature for a period of about 10 minutes to about 3 hours, in order to enable hydrolysis, before being applied by spraying, sprinkling or wiping to the glass substrate which is covered, on one of its main faces, with the silica primer layer.

Procedures known in the technical field of hydrophobic coatings are used to assess the hydrophobicity of the deposits:

### Contact Angle Measurement:

The contact angle of a water droplet (θ) at equilibrium is measured on a 2 μl droplet using a Krüss MSA (Mobile Surface Analyzer) goniometer. The droplet is observed using a high-speed camera, which takes photos from which the contact angle is then recorded. The higher the value of the contact angle, the more hydrophobic is the surface of the sample tested.

### Roll-Off Volume Measurement:

The roll-off volume is measured at an inclination of the glazing of 45°. A series of droplets of calibrated increasing volume are positioned by means of a micropipette on the surface of an inclined glass sheet. Above a certain volume, the droplet will flow by gravity on the surface of the inclined glazing. The roll-off volume is the smallest droplet volume that allows said droplet to flow under its own weight. This measurement is performed with an accuracy of 1 μL.

The general aim is to achieve the lowest possible roll-off volume.

### Resistance to Hydrolysis:

Resistance to hydrolysis is determined by immersing a glass sheet, bearing the hydrophobic coating to be tested, for 7 days in a 35 g/L saline solution at pH=9 (adjusted by NaOH) at 35 °C. After this treatment, the contact angle is measured again.

### Uv Resistance:

Resistance to UV radiation is determined using a QUV device, of QUV—B type, fitted with fluorescent lamps having an irradiance maximum at 313 nm (under the conditions of standard ASTM G-154).

### UV Exposure Tests Alternate:

irradiation phases (fluorescent lamps) at a temperature of 70 °C for 16 hours
dark phases with exposure to moist heat at a temperature of 40 °C, generating condensation on the surface of the samples for 8 hours

The total exposure time for this test is 150 hours.

### EXAMPLES

Glass Substrate Samples Functionalized with Different Alkyltrialkoxysilanes, as Follows:

A 10 cm×10 cm sample is cleaned by polishing using a felt impregnated with an aqueous suspension containing 20% cerium oxide particles. The polished sample is rinsed with distilled water and dried with a dry cloth.

To form the silica primer layer, a 0.3% by weight solution of tetraethoxysilane (TEOS) is prepared in a mixture of 10% acidic water (0.3 N HCl) and 90% isopropanol.

After 30 minutes of reaction at room temperature, this solution is applied to the surface of the glass substrate using a soaked cloth. It is left to dry for about 2 minutes.

Immediately thereafter, a 1.6% solution of alkyltriethoxysilane in a mixture of 10% acidic water (0.3 N HCl) and 90% isopropanol is applied by wiping to the silica primer layer obtained in this way.

It is left to dry for 15 minutes at room temperature, then any white marks are removed by glossing using a cloth soaked in a water/alcohol mixture containing 70% by weight of water and 30% by weight of isopropanol, until all scattering residues have disappeared from the surface of the glazing.

Table 1 shows the contact angle of a water droplet (θ) after deposition of the hydrophobic coating, the roll-off volume on a 45° surface (V₄₅°) after deposition, and the contact angles after hydrolysis and UV exposure of all the samples prepared in this way, compared with a sample according to the prior art that uses a perfluoroalkyltrialkoxysilane.

TABLE 1

| | θ | V₄₅ | θ | θ |
|---|---|---|---|---|
| | after | after | after salt | after UV |
| Alkyl chain length | deposit | deposit | hydrolysis | exposure |
| —C₁ | 80° | 25 μL | 48° | 68° |
| —C₃ | 90 | 40 μL | 84° | 67° |
| —C₅ | 99° | 40 μL | 95° | 60° |
| —C₈ | 105° | 38 μL | 94° | 53° |
| 1H,1H,2H,2H- | 107° | 32 μL | 87° | 99° |
| perfluorooctyltriethoxysilane | | | | |

It is observed that substrates treated with alkyltriethoxysilanes having long alkyl chains (C₅ and C₈) are less sensitive to hydrolysis but more sensitive to UV. The hydrolytic stability of a methylsilane-based coating is insufficient (contact angle below 50 °C). By extrapolating the degradation observed after UV exposure, it appears that alkyl chains containing more than 8 carbons would provide insufficient durability with respect to this environmental factor.

In conclusion, in order to achieve satisfactory durability in terms of sensitivity to hydrolysis and UV, alkylsilanes having C₃₋₈ chains prove to be best.

1. A method for hydrophobicizing a glass substrate, the method comprising successively:
forming a primer layer on one of the main surfaces of the glass substrate,
grafting of a layer of C₃-C₈ alkyltrialkoxysilane and/or C₃-C₈ alkyltrichlorosilane onto the primer layer,
wherein the C₃-C₈ alkyltrialkoxysilane is an alkyltrialkoxysilane of formula CₙH₂ₙ₊₁SiR₃, where n=3-8, each R representing a C₁₋₃ alkoxy group, and
wherein the C₃-C₈ alkyltrichlorosilane is an alkyltrichlorosilane of formula CₙH₂ₙ₊₁SiR₃, where n=3-8, each R representing a chlorine atom.

2. The method according to claim 1, further comprising, after the grafting, a glossing step using a cloth soaked in a water/alcohol mixture containing from 30% to 90% by weight of water.

3. The method according to claim 1, wherein the C₃-C₈ alkyltrialkoxysilane is an alkyltrialkoxysilane of formula CₙH₂ₙ₊₁SiR₃, where n=5-8, and each R represents a C₁₋₃ alkoxy group.

4. The method according to claim 1, wherein the C₃-C₈ alkyltrichlorosilane is an alkyltrichlorosilane of formula CₙH₂ₙ₊₁SiR₃ where n=5-8, and each R represents a chlorine atom.

5. The method according to claim 3, wherein n=8.

6. The method according to claim 1, wherein the primer layer is made of silica and that the silica primer layer is formed in a sol-gel step wherein a tetrachlorosilane and/or tetraalkoxysilane is hydrolyzed in an acidic aqueous-alcoholic medium.

7. The method according to claim 6, wherein the sol-gel step for forming the silica primer layer is carried out with an acidic aqueous-alcoholic solution containing from 0.1% to 1% by weight of tetrachlorosilane and/or tetraalkoxysilane in a water/alcohol mixture containing 3 to 50% by weight of water, a pH of which has previously been adjusted to a value between 0 and 3.

8. The method according to claim 7, wherein the aqueous-alcoholic solution of tetrachlorosilane and/or tetraalkoxysilane is left at room temperature for a period of between 2 minutes and 2 hours before being applied to the glass substrate by immersion, curtain coating, spraying or wiping.

9. The method according to claim 1, wherein the grafting of C₃-C₈ alkyltrialkoxysilane and/or C₃-C₈ alkyltrichlorosilane is carried out by a sol-gel step wherein the C₃-C₈ alkyltrialkoxysilane and/or the C₃-C₈ alkyltrichlorosilane is hydrolyzed in an acidic aqueous-alcoholic medium.

10. The method according to claim 9, wherein the grafting of C₃-C₈ alkyltrialkoxysilane and/or C₃-C₈ alkyltrichlorosilane is carried out using an acidic aqueous-alcoholic solution containing from 0.1% to 4% by weight of C₃-C₈ alkyltrialkoxysilane and/or C₃-C₈ alkyltrichlorosilane in a water/alcohol mixture containing 5 to 70% by weight of water.

11. The method according to claim 10, wherein the aqueous-alcoholic solution of C₃-C₈ alkyltrialkoxysilane and/or C₃-C₈ alkyltrichlorosilane is left at room temperature for a period of about 10 minutes to about 3 hours, before being applied, by spraying or wiping, to the glass substrate which is covered, on one of its main faces, with the silica primer layer.

12. The method according to claim 1, wherein the grafting of C₃-C₈ alkyltrialkoxysilane and/or C₃-C₈ alkyltrichlorosilane is carried out after at least 2 minutes of drying of the silica primer layer at room temperature.

13. A hydrophobic glass substrate obtained by means of the method according to claim 1, comprising a transparent glass substrate which is covered, on one of its main faces, with a silica primer layer, said silica primer layer being grafted with C₃-C₈ alkylsilyl groups, said alkyl group corresponding to formula (CₙH₂ₙ₊₁), where n=3-8.

14. The hydrophobic glass substrate according to claim 13, wherein n=5-8.

15. The hydrophobic glass substrate according to claim 13, wherein the silica primer layer has a thickness of between 5 nm and 250 nm.

16. The hydrophobic glass substrate according to claim 13, wherein the hydrophobic glass substrate is an aircraft cockpit glazing.

17. The method according to claim 1, wherein the glass substrate is an aircraft cockpit glazing.

18. The method according to claim 1, wherein the prima layer is silica.

19. The method according to claim 1, wherein the C₁₋₃ alkoxy group is a methoxy or ethoxy group.

20. The method according to claim 1, wherein the water/alcohol mixture is a water/isopropanol mixture.
